(19) United States
(12) Patent Application Publication
(10) Pub. No.: US 2015/0062963 A1
(43) Pub. Date: Mar. 5, 2015

(54) ILLUMINATION SYSTEM AND METHOD FOR BACKLIGHTING

(71) Applicants: Noam MEIR, Herzlia (IL); Benie Eli Etkes - Surveying and Engineering Instrumetns Ltd., Zofit (IL)

(72) Inventor: Noam Meir, Herzlia (IL)

(73) Assignee: Noam MEIR, Herzlia (IL)

(21) Appl. No.: 14/389,405

(22) PCT Filed: Mar. 28, 2013
(86) PCT No.: PCT/IL2013/050294

§ 371 Date: Sep. 30, 2014

Related U.S. Application Data
(60) Provisional application No. 61/793,756, filed on Mar. 15, 2013.
(60) Provisional application No. 61/618,703, filed on Mar. 31, 2012.

(51) Int. Cl. F21V 8/00

(52) U.S. Cl. CPC G02B 6/005; G02B 6/0076; G02B 6/0053
USPC 362/607; 362/606

(57) ABSTRACT

A system for providing backlight illumination is disclosed. The system comprises a plurality of light-emitting sheets arranged in a partially-overlapping configuration, and a light-conversion layer spaced from the sheets and having therein light-conversion structures for spectrally converting light emitted from the sheets.

### RELATED APPLICATIONS

This application claims the benefit of priority of U.S. Provisional Patent Application Nos. 61/618,703 filed Mar. 31, 2012 and 61/793,756 filed Mar. 15, 2013, the contents of which are incorporated herein by reference in their entirety.

### FIELD AND BACKGROUND OF THE INVENTION

The present invention, in some embodiments thereof, relates to backlighting and, more particularly, but not exclusively, to an illumination system and method for utilizing a light conversion molecule for providing backlight illumination.

Electronic display devices may generally be categorized into active display devices and passive display devices. The active display devices include the cathode ray tube (CRT), plasma display panel (PDP) and electroluminescent display (ELD). The passive display devices include liquid crystal display (LCD), electrochemical display (ECD) and electrophoretic image display (EPID). In active display devices, each pixel radiates light independently. Passive display devices, on the other hand, do not produce light within the pixel and the pixel is only able to block light.

Of the above display technologies, the passive display device, and in particular the LCD device has become the leading technology due to its proven high quality and small form factor (slimness). LCD devices are currently employed in many applications (cellular phones, personal assistance devices, tablets, desktop monitors, portable computers, television displays, etc.), and there is a growing attention to devise backlight high-quality assemblies for improving the image quality inn these applications.

In LCD devices, an electric field is applied to liquid crystal molecules, and an alignment of the liquid crystal molecule is changed depending on the electric field, to thereby change optical properties of the liquid crystal, such as double refraction, optical rotatory power, dichroism, light scattering, etc. Since LCD are passive, they display images by reflecting external light transmitted through an LCD panel or by using the light emitted from a light source, e.g., a backlight assembly, disposed behind the LCD panel.

Backlight assemblies are designed to achieve many goals, including high brightness, large area coverage, uniform luminance throughout the illuminated area, controlled viewing angle, small thickness, low weight, low power consumption and low cost.

A typical LCD device includes an LCD panel and backlight assembly. The LCD panel includes an arrangement of LCD pixels, which are typically formed of thin film transistors fabricated on a transparent substrate with liquid crystal sandwiched between them and the color filters. The color filters which are fabricated on another transparent substrate produce colored light by transmitting only one third of the light produced by each pixel. Thus, each LCD pixels is composed of three sub-pixels. The thin film transistors are addressed by gate lines to perform display operation by way of the signals applied thereto through display signal lines. The signals charge the liquid crystal layer in the vicinity of the respective thin film transistors to effect a local change in optical properties of the liquid crystal layer.

In operation, the backlight assembly produces white illumination directed toward the liquid crystal pixels. The optical properties of the liquid crystal layer are locally modulated by the thin film transistors to create a light intensity modulation across the area of the display. Specifically, a static polarizer polarizes the light produced by the backlight assembly, and the liquid crystal pixels selectively manipulate the polarization of the light passing therethrough. The light intensity modulation is achieved using a static polarizer positioned in front of the liquid crystal pixels which prevents transmission of light of certain polarization. The color filters colorize the intensity-modulated light emitted by the pixels to produce a color output. By selective opacity modulation of neighboring pixels of the three color components, selected intensities of the three component colors are blended together to selectively control color light output. Selective the blending of three primary colors such as red, green, and blue (RGB) can generally produce a full range of colors suitable for color display purposes.

Traditionally, Cold Cathode Fluorescent tubes Light (CCFL) has been employed for LCD backlighting. A fluorescent lamps and optics are deployed for homogenously scattering the light across the LCD panel and color filters are deployed for separating between the colors. A diffuser layer and a reflector are used for further homogenizing the backlight spectrum and reducing optical leakage, respectively. To assure sufficient light transmission, color filters of relatively wide spectrum are used.

In more advanced technique, a backlight assembly of LCD includes an array of Light Emitting Diodes (LEDs) for emitting white or RGB light, a light guiding plate for guiding the light toward the LCD panel, and a diffuser layer positioned between the LCD panel and the LEDs for homogenizing the backlight spectrum at the LCD panel. Oftentimes, a reflector is disposed behind the light guiding plate to reflect the lights leaked from the light guiding plate toward the light guiding plate. The LEDs, due to their inherent narrow color spectrum, can improve the overall LCD color gamut. In addition, the LEDs are Hg free, they provide higher brightness to size ratio, have increased longevity, and can be incorporated in a more robust design. The key issue in introducing LEDs is in finding an efficient way for homogenously spread the LED light over the backlighting panel. Such types of backlight assemblies are disclosed, for example, U.S. Pat. Nos. 6,608,614, 6,930,737, and in U.S. Patent Application Nos. 20040264911, 20050073495 and 20050117320.

In another conventional backlighting technique, the colors are separated (instead of being filtered) by prism positioned behind the LCD sub-pixels. Such types of backlight assemblies are disclosed, for example, in U.S. Pat. Nos. 5,748,828, 6,104,446 and in references included therein.

In an additional conventional backlighting technique, the colors are guided separately to their destined column of sub-pixels rather than being mixed to white light. Red, green and blue LEDs are coupled to separate optical fibers. The optical fibers illuminate the positions of the red, green and blue pixels of the LCD. The LEDs are constantly on and there is no color filtering. Such types of backlight assemblies are disclosed, for example, in U.S. Pat. Nos. 6,768,525 and partially also by U.S. Pat. Nos. 6,104,371 and 6,288,700.

U.S. Pat. No. 8,272,758, the contents of which are hereby incorporated by reference, discloses an illumination apparatus which comprises a light-emitting source and a photoluminescent material wherein both the light-emitting source and the photoluminescent material are embedded in a waveguide. The photoluminescent material converts some of the light from the light-emitting source to a different wavelength. The converted light is mixed with the unconverted light and forms output light which is spectrally different from both the converted light and the unconverted light.

U.S. Pat. No. 7,826,698, the contents of which are hereby incorporated by reference, discloses a planar illumination area, which is substantially free of stitch artifacts. The planar illumination area includes discrete light-guide elements. Light in a first element striking its sidewall is reflected therefrom rather than travelling into a second light-guide element. Light in a second element striking its sidewall is substantially reflected therefrom rather than travelling into the first light-guide element. A third element is arranged to form an overlapping region with the first element and to emit a substantially uniform light output.

### SUMMARY OF THE INVENTION

According to an aspect of some embodiments of the present invention there is provided a system for providing backlight illumination. The system comprises: a plurality of light-emitting sheets arranged in a partially-overlapping configuration, and a light-conversion layer spaced from the sheets and having therein light-conversion structures for spectrally converting light emitted from the sheets, and for reducing non-uniformities in light intensity at regions of overlap between the sheets.

According to some embodiments of the invention the light-conversion structures are distributed non uniformly over the light-conversion layer.

According to some embodiments of the invention system comprises a faceted optical film spaced from the light-conversion layer and configured for redirecting light exiting the light-conversion layer to provide a redirected white light output characterized by a color coordinate.

According to some embodiments of the invention the density of the structures in the layer is lower than a density of the structures that would have been required for providing white light characterized by the color coordinate in the absence of the film.

According to some embodiments of the invention at least one of the sheets is embedded with a blue light source and at least one of a red light source and a green light source.

According to some embodiments of the invention at least one of the sheets is embedded with a first blue light source and a second blue light source each emitting blue light of a different wavelength.

According to some embodiments of the invention the first blue light source has a characteristic emission wavelength of about 450 nm, and the second blue light source has a characteristic emission wavelength of about 480 nm.

According to some embodiments of the invention the invention the system comprises: a power source connected to the red the green and the blue light sources, wherein the connection to the blue light source is independent from the connection to the red and the green light sources; and a controller, for activating the power source responsively to an operation mode signal, wherein when the signal corresponds to a first operation mode, the controller activates the power source to power each of the red, the green and the blue light sources, and when the signal corresponds to a second operation mode, the controller activates the power source to power at least one of the red and the green and light source, but not the blue light source.

According to some embodiments of the invention the invention the system comprises a user interface for allowing a user to select between the first operation mode and the second operation mode.

According to some embodiments of the invention the invention the system comprises a light sensor for determining ambient light condition, wherein the controller automatically selects between the first operation mode and the second operation mode responsively to the ambient light condition.

According to some embodiments of the invention the invention at least one of the sheets is embedded with a first set of light sources configured for generating light at a first continuous luminance range, and a second set of light sources configured for generating light at a second continuous luminance range being different from the first luminance range.

According to some embodiments of the invention the system comprises a controller for independently activation the sets of light sources so as to provide a white light output characterized by a predetermined color coordinate for any luminance within a combined luminance range encompassing both the first and the second luminance ranges.

According to some embodiments of the invention the second set of light sources is configured for generating a non-converted light and wherein the light-conversion layer is selected so as to convert a portion of the non-converted light such that a combination of a converted portion and a non-converted portion is generally white.

According to some embodiments of the invention the invention the combined luminance range is defined from a minimal luminance to a maximal luminance and wherein the maximal luminance is at least 100,000 times higher than the minimal luminance.

According to some embodiments of the invention the invention the first and the second sets of light sources are arranged in the sheet such that light emitted by light sources of the second set does not impinge on light sources of the first set.

According to some embodiments of the invention the invention at least one of the sheets is embedded with a light emitting system having a multilayer structure, the multilayer structure comprising: a semiconductor light-emitting layer; a light-conversion layer directly contacting the semiconductor layer and having therein light-conversion structures for spectrally converting light emitted from the semiconductor layer; an infrared filter layer directly contacting the light-conversion layer and configured for filtering out at least a portion of infrared light exiting the light-conversion layer; and a infrared absorbing layer, directly contacting the infrared filter layer and configured for absorbing a portion of infrared light exiting the infrared filter layer.

According to some embodiments of the invention an aggregate thickness of the semiconductor light-emitting layer, the light-conversion layer, the infrared filter layer and the infrared absorbing layer is less than 2 mm.

According to some embodiments of the invention each sheet comprises an in-coupling region and an out-coupling region, wherein two adjacent sheets are arranged such an out-coupling region of one sheet overlays an in-coupling region of another sheet.

According to some embodiments of the invention the sheets are designed and constructed so as not to block emission of light from the in-coupling region.

According to some embodiments of the invention a density of the light-conversion structures is higher at regions of the light conversion layer that overlay the in-coupling region than at regions of the light conversion layer that overlay the out-coupling region.

According to some embodiments of the invention a thickness of the light-conversion structures is lower at regions of the light conversion layer that overlay the in-coupling region than at regions of the light conversion layer that overlay the out-coupling region.

According to some embodiments of the invention the light-conversion structures comprise light-conversion molecules or particles.

According to some embodiments of the invention the light-conversion molecules or particles effect phosphorescence.

According to some embodiments of the invention the light-conversion structures comprise at least one structure exhibiting quantum confinement.

According to some embodiments of the invention the structure exhibiting quantum confinement is selected from the group consisting of a quantum dot, a quantum wire and a quantum well.

According to some embodiments of the invention the light-conversion layer is configured to absorb blue light and responsively emit yellow light.

According to some embodiments of the invention the light-conversion layer is configured to absorb infrared light and responsively emit visible light.

According to an aspect of some embodiments of the present invention there is provided a system for providing backlight illumination. The system comprises: a light-emitting sheet; a light-conversion layer spaced from the sheet and having therein light-conversion structures for spectrally converting light emitted from the sheet; and a faceted optical film spaced from the light-conversion layer and configured for redirecting light exiting the light-conversion layer to provide a redirected white light output characterized by a color coordinate.

According to some embodiments of the invention the system wherein a density of the structures in the layer is lower than a density of the structures that would have been required for providing white light characterized by the color coordinate in the absence of the film.

According to an aspect of some embodiments of the present invention there is provided a system for providing a backlight illumination. The system comprises: a light-emitting sheet embedded with at least a red light source, a green light source and a blue light source; a power source connected to the red the green and the blue light sources, wherein the connection to the blue light source is independent from the connection to the red and the green light sources; and a controller, for activating the power source responsively to an operation mode signal, wherein when the signal corresponds to a first operation mode, the controller activates the power source to power each of the red, the green and the blue light sources, and when the signal corresponds to a second operation mode, the controller activates the power source to power at least one of the red and the green and light source, but not the blue light source.

According to some embodiments of the invention the system comprises a user interface for allowing a user to select between the first operation mode and the second operation mode.

According to some embodiments of the invention the system comprises a light sensor for determining ambient light condition, wherein the controller automatically selects between the first operation mode and the second operation mode responsively to the ambient light condition.

According to an aspect of some embodiments of the present invention there is provided a method of providing a backlight illumination, comprising selecting an operation mode and activation the system as delineated hereinabove and optionally as further detailed hereinunder.

According to an aspect of some embodiments of the present invention there is provided a system for providing backlight illumination. The system comprises: a light-emitting sheet embedded with a first set of light sources configured for generating light at a first continuous luminance range, and configured for generating light at a second continuous luminance range being different from the first luminance range; and a controller for independently activation the sets of light sources so as to provide a white light output characterized by a predetermined color coordinate for any luminance within a combined luminance range encompassing both the first and the second luminance ranges.

According to some embodiments of the invention the system comprises a light-conversion layer spaced from the sheet and having therein light-conversion structures for spectrally converting light emitted from the light sources.

According to some embodiments of the invention the first luminance range comprises luminance values which are higher than any luminance value within the second luminance range, wherein the first set of light sources is configured to generate a spectrally converted light, and wherein the light-conversion layer is selected so as to further convert a portion of the spectrally-converted light to form a generally white light mixture.

According to some embodiments of the invention the second set of light sources is configured for generating non-converted light and wherein the light-conversion layer is selected so as to convert a portion of the non-converted light such that a combination of a converted portion and a non-converted portion is generally white.

According to some embodiments of the invention the combined luminance range is defined from a minimal luminance to a maximal luminance and wherein the maximal luminance is at least 100,000 times or at least 200,000 times or at least 300,000 times or at least 400,000 times or at least 500,000 times or at least 600,000 times or at least 700,000 times or at least 800,000 times higher than the minimal luminance.

According to an aspect of some embodiments of the present invention there is provided a light emitting system. The system comprises: a multilayer structure having: a semiconductor light-emitting layer; a light-conversion layer directly contacting the semiconductor layer and having therein light-conversion structures for spectrally converting light emitted from the semiconductor layer; an infrared filter layer directly contacting the light-conversion layer and configured for filtering out at least a portion of infrared light exiting the light-conversion layer; and a infrared absorbing layer, directly contacting the infrared filter layer and configured for absorbing a portion of infrared light exiting the infrared filter layer.

According to some embodiments of the invention an aggregate thickness of the semiconductor light-emitting die layer, the light-conversion layer, the infrared filter layer and the a infrared absorbing layer is less than 2 mm.

According to an aspect of some embodiments of the present invention there is provided a passive display system comprising the system as delineated above and optionally as further detailed hereinunder.

According to an aspect of some embodiments of the present invention there is provided a method of designing a backlight system having a light-emitting sheet and a light-conversion layer spaced from the sheet and having therein light-conversion structures for spectrally converting light emitted from the sheet. The method comprises: determining a characteristic emission direction of blue light out of the light-emitting sheet; and selecting a thickness of the light-conversion layer responsively to the characteristic emission direction so as to establish a predetermined optical path length of the blue light in the light-conversion layer.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions.

Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings and images. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of an illumination apparatus;

FIG. 2 is a schematic illustration of a cross-sectional view of a system for providing backlight illumination, according to some embodiments of the present invention;

FIGS. 3A-B are schematic illustrations of a system for providing backlight illumination in embodiments in which the system comprises several sets of light sources, each being configured for generating light at a different luminance range;

FIG. 4 is a schematic illustration of a system for providing backlight illumination in embodiments in which the system comprises a plurality of light-emitting sheets;

FIG. 5 is a schematic illustration of a light emitting system, according to some embodiments of the present invention;

FIG. 6 is a schematic illustration of a passive display system, according to some embodiments of the present invention;

FIGS. 7A-B show color coordinates over the 1931 CIE color coordinate system;

FIG. 8 is a schematic illustration of a tiling configuration according to some embodiments of the present invention;

FIGS. 9A-B are schematic illustrations of top views of light emitting sheets, showing light propagations for the case of an externally coupled light source (FIG. 9A) and an embedded light source (FIG. 9B); and

FIGS. 10A-D are images captured during experiments performed in accordance with some embodiments of the present invention under sunlight conditions.

### DESCRIPTION OF SPECIFIC EMBODIMENTS OF THE INVENTION

The present invention, in some embodiments thereof, relates to backlighting and, more particularly, but not exclusively, to a backlight system and a backlighting method utilizing a light conversion molecule.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

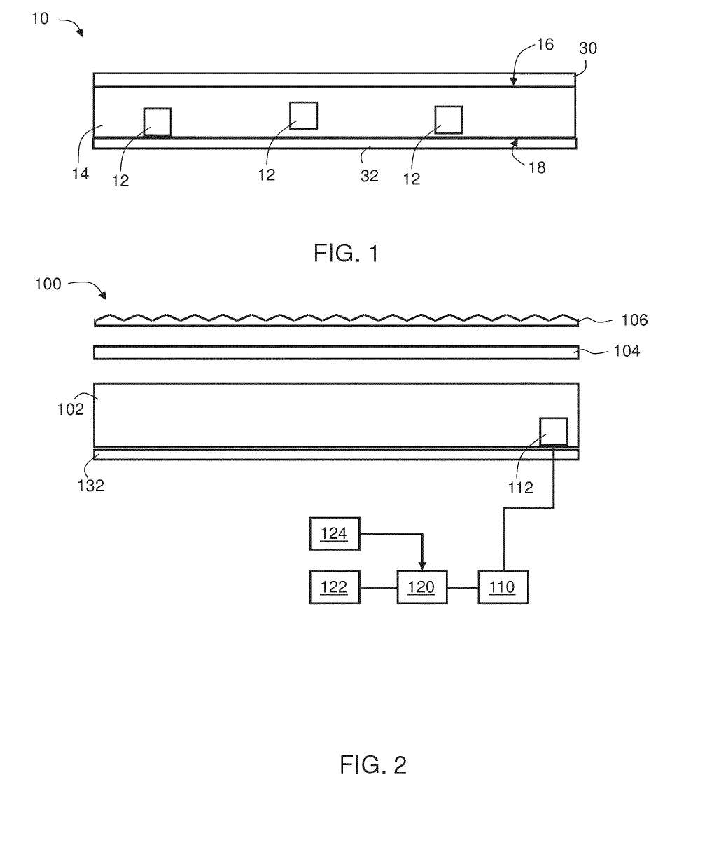

For purposes of better understanding some embodiments of the present invention, as illustrated in FIGS. 2-11 of the drawings, reference is first made to the construction and operation of an illumination apparatus 10 as described in U.S. Pat. No. 8,272,758 and illustrated in FIG. 1.

Apparatus 10 comprises one or more light emitting sources 12 embedded in a waveguide material 14 having a first surface 16 and a second surface 18. Waveguide material 14 is capable of propagating light generated by light source 12, such that at least a portion of the light is diffused within waveguide material 14 and exits through at least a portion of first surface 16.

The terms “light source” or “light emitting source”, are used herein interchangeably and refer to any self light emitting element, including, without limitation, an inorganic light emitting diode, an organic light emitting diode or any other electroluminescent element. The term “light source” as used herein refers to one or more light sources.

As used herein, the term “organic” includes polymeric materials as well as small molecule organic materials that may be used to fabricate organic opto-electronic devices. “Small molecule” refers to any organic material that is not a polymer, and “small molecules” may actually be quite large. Small molecules may include repeat units in some circumstances. For example, using a long chain alkyl group as a substituent does not remove a molecule from the “small molecule” class. Small molecules may also be incorporated into polymers, for example as a pendent group on a polymer backbone or as a part of the backbone. Small molecules may also serve as the core moiety of a dendrimer, which consists of a series of chemical shells built on the core moiety. The core moiety of a dendrimer may be a fluorescent or phosphorescent small molecule emitter. A dendrimer may be a “small molecule,” and it is believed that all dendrimers currently used in the field of OLEDs are small molecules.

Organic light emitting diodes suitable for the present embodiments can be bottom emitting OLEDs, top emitting OLEDs and side emitting OLEDs, having one or two transparent electrodes.

As used herein, “top” refers to furthest away from surface 18, while “bottom” refers to closest to surface 18.

The waveguide material according to embodiments of the present invention may be similar to, and/or be based on, the teachings of U.S. patent application Ser. Nos. 11/157,190, 60/580,705 and 60/687,865, all assigned to the common assignee of the present invention and fully incorporated herein by reference. Alternatively, the waveguide material according to some embodiments of the present invention may also have other configurations and/or other methods of operation as further detailed hereinunder.

Waveguide material 14 can be translucent or clear as desired. In any event, since waveguide material 14 propagates and emits the light emitted by light source 12, it is transparent at least to the characteristic emission spectrum of light source 12. The characteristic emission spectrum of the light source is also referred to herein as “the color” of the light source. Thus, for example, a light emitting source characterized by a spectrum having an apex at a wavelength of from about 420 to about 500 nm, is referred to as a “blue light source”, a light emitting source characterized by a spectrum having an apex at a wavelength of from about 520 to about 580 nm, is referred to as a “green light source”, a light emitting source characterized by a spectrum having an apex at a wavelength of about 620-680 nm, is referred to as a “red light source”, and so on for other colors. This terminology is well-known to those skilled in the art of optics.

As used herein the term “about” refers to ±10%.

Waveguide material 14 is optionally and preferably flexible, and may also have a certain degree of elasticity. Thus, material 14 can be, for example, an elastomer.

Apparatus 10 comprises a reflecting surface 32 which prevents emission of light through surface 18 and therefore enhances emission of light through surface 16. Surface 32 can be made of any light reflecting material, and can be either embedded in or attached to waveguide material 14.

There are several advantages for embedding the light source within the waveguide material. One advantage is that all the light emitted from the light source eventually arrives at the waveguide material. When the light source is externally coupled to the waveguide material, some of the light scatters at wide angle and does not impinge the waveguide material. Thus, the embedding of light source 12 in waveguide material 14 allows to efficiently collect the emitted light.

Another advantage is the optical coupling between the light source and the waveguide material in particular when the light source is a light emitting diode. When the diode is externally coupled to the waveguide material, the light emitted from the p-n junction should be transmitted out of the diode into the air, and subsequently from the air into the waveguide material. The mismatch of impedances in each such transition significantly reduces the coupling efficiency due to unavoidable reflections when the light passes from one medium to the other. On the other hand, when the diode is embedded in waveguide material, there is a direct transition of light from the diode to the waveguide material with higher overall transmission coefficient. To further improve the coupling efficiency, the waveguide material is preferably selected with a refraction index which is close to the refraction index of the diode. Typical difference in refraction indices is from about 0.5 to about 1.6.

Light source 12 can be a LED, which includes the bare die and all the additional components packed in the LED package, or, more preferably, light source 12 can include the bare die, excluding one or more of the other components (e.g., reflecting cup, silicon, LED package and the like).

As used herein “bare die” refers to a p-n junction of a semiconductor material. When a forward biased is applied to the p-n junction through electrical contacts connected to the p side and the n side of the p-n junction, the p-n junction emits light at a characteristic spectrum.

Thus, in various exemplary embodiments of the invention, light source 12 includes or consists essentially of only the semiconductor p-n junction and the electrical contacts. Also contemplated are configurations in which several light sources are LEDs, and several light sources are bare dies with electrical contacts connected thereto.

The advantage of using a bare die rather than a LED is that some of the components in the LED package including the LED package absorb part of the light emitted from the p-n junction and therefore reduce the light yield.

Another advantage is that the use of bare die reduces the amount of heat generated during light emission. This is because heat is generated due to absorption of light by the LED package and reflecting cup. The consequent increase in temperature of the p-n junction causes thermal imbalance which is known to reduce the light yield. Since the bare die does not include the LED package and reflecting cup, the embedding of a bare die in the waveguide material reduces the overall amount of heat and increases the light yield. The elimination of the LED package permits the use of many small bare dies instead of each large packaged LED. Such configuration allows operating each bare die in low power while still producing sufficient overall amount of light, thereby to improving the p-n junction efficacy. The present inventor found that the elimination of the LED package allows using relatively large LED dies while maintaining thin form factor since the dimensions of the dies are much smaller than those of packaged LED. This allows operating the LED at much higher efficacy.

An additional advantage is light diffusion within the waveguide material. The minimization of redundant components in the vicinity of the p-n junction results in almost isotropic emission of light from the p-n junction which improves the diffusion of light. To further improve the coupling efficiency, the waveguide material is preferably selected with a refraction index which is close to the refraction index of the p-n junction.

Light source 12 can be embedded in the bulk of waveguide material 14 or near surface 18.

Waveguide material 14 is capable of propagating and diffusing the light until it exits though surface 16 or a portion thereof.

The distribution of light sources within the waveguide material and/or the optical properties of the waveguide material may be selected to provide the suitable illumination for the specific application for which apparatus 10 is used. More specifically, apparatus 10 may provide illumination at a predetermined light profile, which is manifested by a predetermined intensity profile, predetermined brightness profile, and/or predetermined color profile.

For example, light sources emitting different colors of light (i.e., light sources having different characteristic emission spectra, which may or may not have spectral overlaps therebetween), for example two, three, or more different colors, may be distributed in the waveguide such that surface 16 emits light at a predetermined light profile. Additionally, the optical properties of the waveguide material may be made local and wavelength-dependent according to the predetermined light profile. More specifically, according to the presently preferred embodiment of the invention, different regions in the waveguide material have a different response to different light spectra.

Apparatus 10 includes one or more photoluminescent materials 30 coating surface 16 or a portion thereof. Photoluminescent material 30 may include or consist essentially of, e.g., a phosphor or a fluorophore. Photoluminescent material 30 can be disposed or dispersed within a phosphor-encapsulating material having an index of refraction less than the index of refraction of waveguide material 14. For example, waveguide material 14 may include or consist essentially of polymethylmethacrylate (PMMA) having an index of refraction of approximately 1.5, and photoluminescent material 30 may be disposed within a phosphor-encapsulating material including or consisting essentially of silicone having an index of refraction of approximately 1.4. The phosphor-encapsulating material may be present as a discrete layer, “foil,” or “module” disposed on apparatus 10 (e.g., on surface 16), or may be disposed within apparatus 10. The phosphor-encapsulating material can be disposed over but not in optical contact with apparatus 10 (e.g., with surface 16). The phosphor-encapsulating material can be disposed in mechanical contact with apparatus 10, but, e.g., an optical adhesive may not be utilized, thereby leaving an air gap (having a thickness on the micrometer scale) therebetween. The air gap facilitates light entering the phosphor-encapsulating material having been out-coupled from apparatus 10 by design rather than due to any index of refraction difference between the phosphor-encapsulating material and waveguide material 14.

Photoluminescent material 30 can also be disposed neither on surface 16 nor directly on light source 12. Rather, the photoluminescent material (e.g., in the form of particles and/or layer(s)) can be disposed within apparatus 10 some distance away from light source 12 (including, e.g., disposed proximate and/or in direct contact with an encapsulant around light source 12).

The term “photoluminescent material” is commonly used herein to describe one or a plurality of photoluminescent materials (which exhibit, for example, chemoluminescence, fluorescence, and/or phosphorescence), e.g., in layered or mixed form. Additionally, a photoluminescent material may comprise one or more types of photoluminescent molecules. In any event, a photoluminescent material is characterized by an absorption spectrum (i.e., a range of wavelengths of light which may be absorbed by the photoluminescent molecules to effect quantum transition to a higher energy level) and an emission spectrum (i.e., a range of wavelengths of light which are emitted by the photoluminescent molecules as a result of quantum transition to a lower energy level). The emission spectrum of the photoluminescent layer is typically wider and shifted relative to its absorption spectrum. The difference in wavelength between the apex of the absorption and emission spectra of the photoluminescent material is referred to as the Stokes shift of the photoluminescent material.

The absorption spectrum of photoluminescent material 30 preferably overlaps the emission spectrum of at least one of light sources 12. More preferably, for each characteristic emission spectrum of an embedded light source, there is at least one photoluminescent material having an absorption spectrum overlapping the emission spectrum the light source. According to a preferred embodiment of the present invention, the apex of the light source's emission spectrum lies in the spectrum of the photoluminescent material, and/or the apex of the photoluminescent material's absorption spectrum lies in the spectrum of the light source.

Photoluminescent material 30 serves to “convert” the wavelength of a portion of the light emitted by light sources 12. More specifically, for at least one photon that is successfully absorbed by material 30, a new photon is emitted. Depending on the type of photoluminescent material, the emitted photon may have a wavelength which is longer or shorter than the wavelength of the absorbed photon. Photons that do not interact with material 30 may propagate therethrough. The combination of converted light and non-converted light preferably forms the light profile of apparatus 10.

Phosphors are widely used for coating individual LEDs, typically in the white LED industry. However, photoluminescent materials covering an illuminating surface of a waveguide material such as the waveguide material of the present embodiments have not been employed. An advantage of using material 30 over waveguide material 14, as opposed to on each individual light-emitting source 12, is that waveguide material 14 first diffuses the light and thereafter emits it through surface 16. Thus, instead of collecting light from a point light source (e.g., an LED), material 30 collects light from a surface light source having a predetermined area (surface 16 or a portion thereof). This configuration allows better control of the light profile provided by apparatus 10.

Many types of phosphorescent and fluorescent substances are suitable for photoluminescent material 30. Representative examples include, without limitation, the phosphors disclosed in U.S. Pat. Nos. 5,813,752, 5,813,753, 5,847,507, 5,959,316, 6,155,699, 6,351,069, 6,501,100, 6,501,102, 6,522,065, 6,614,179, 6,621,211, 6,635,363, 6,635,987, 6,680,004, 6,765,237, 6,853,131, 6,890,234, 6,917,057, 6,939,481, 6,982,522, 7,015,510, 7,026,756, 7,045,826, and 7,005,086, the entire disclosure of each of which is incorporated by reference herein.

Although apparatus 10 may be designed to provide any light profile, for many applications it is desired to construct apparatus 10 to provide substantially uniform illumination. Apparatus 10 may provide illumination characterized by a uniformity of at least 70%, or at least 80%, or at least 90%. This is particularly useful when apparatus 10 is incorporated in a backlight unit of a passive display device.

White light illumination may be provided in more than one way. The waveguide material can be embedded with red light sources, green light sources, blue light sources, and optionally light sources of other colors (e.g., orange, yellow, green-yellow, cyan, amber, blue-violet) that are distributed such that the combination of red light, green light, blue light, and optionally light in the other colors appears as substantially uniform white light across the area of surface 16 or a portion thereof.

Alternatively, material 30 converts the light emitted by light sources 12 to substantially white light, e.g., using a dichromatic, trichromatic, tetrachromatic, or multichromatic approach.

For example, a blue-yellow dichromatic approach may be employed, in which blue light sources (e.g., bare dies of InGaN with a peak emission wavelength at about 460 nm), may be distributed in waveguide material 14, and material 30 may be made of phosphor molecules with absorption spectra in the blue range and emission spectra extending to the yellow range (e.g., cerium-activated yttrium aluminum garnet, or strontium silicate europium). Since the scattering angle of light sharply depends on the frequency of the light (fourth-power dependence for Rayleigh scattering, or second-power dependence for Mie scattering), the blue light generated by the blue light sources is efficiently diffused in the waveguide material and exits, substantially uniformly, through surface 16 into layer 30. Material 30, which has no preferred directionality, emits light in its emission spectrum and complements the blue light which is not absorbed to white light.

In other dichromatic configurations, ultraviolet light sources (e.g., bare dies of GaN, AlGaN and/or InGaN with a peak emission wavelengths between 360 nm and 420 nm), may be distributed in waveguide material 14. Light of such ultraviolet light sources is efficiently diffused in the waveguide material and exits, substantially uniformly, through surface 16. To provide substantially white light, two photoluminescent layers are preferably disposed on surface 16. One layer may be characterized by an absorption spectrum in the ultraviolet range and emission spectrum in the orange range (with peak emission wavelength from about 570 nm to about 620 nm), and another layer characterized by an absorption spectrum in the ultraviolet range and emission spectrum in the blue-green range (with peak emission wavelength from about 480 nm to about 500 nm). The orange light and blue-green light emitted by the two photoluminescent layers blend to appear as white light to an observer. Since the light emitted by the ultraviolet light sources is above or close to the end of visual range, it is not seen by the observer. The two photoluminescent layers are preferably disposed one on top of the other (in direct physical contact) to improve the uniformity. Alternatively, a single layer having two types of photoluminescent materials with the above emission spectra may be utilized.

A trichromatic approach can also be employed. For example, blue light sources may be distributed in the waveguide material as described above, with two photoluminescent layers deposited on surface 16. A first photoluminescent layer may include or consist essentially of phosphor molecules with absorption spectra in the blue range and emission spectra extending to the yellow range as described above, and a second photoluminescent layer may include or consist essentially of phosphor molecules with absorption spectra in the blue range and emission spectra extending to the red range (e.g., cerium-activated yttrium aluminum garnet doped with a trivalent ion of praseodymium, or europium-activated strontium sulphide). The unabsorbed blue light, the yellow light, and the red light blend to appear as white light to an observer.

Light sources with different emission spectra can be distributed and several photoluminescent layers can be utilized, such that the absorption spectrum of each photoluminescent layer overlaps one of the emission spectra of the light sources, and all of the emitted colors (of the light sources and the photoluminescent layers) blend to appear as white light. The advantages of such a multi-chromatic configuration are that it provides high-quality white balance because it allows better control on the various spectral components of the light in a local manner across the surface of the illumination apparatus, and delivers a high color rendering index (CRI) for general lighting applications.

The color composite of the white output light may depend on the intensities and spectral distributions of the emanating light emissions. These depend on the spectral characteristics and spatial distribution of the light sources, and, in the embodiments in which one or more photoluminescent layers are employed, on the spectral characteristics of the photoluminescent layer(s) and the amount of unabsorbed light. The amount of light that is unabsorbed by the photoluminescent layer(s) is in turn a function of the thickness of the photoluminescent layer(s), the density of photoluminescent material(s), and the like. By judiciously selecting the emission spectra of light-emitting source 12 and optionally the thickness, density, and spectral characteristics (absorption and emission spectra) of material 30, apparatus 10 may be made to serve as an illumination surface (either planar or non planar, either stiff or flexible) that provides substantially uniform white light.

The “whiteness” of the light may be tailored according to the specific application for which apparatus 10 is used. For example, when apparatus 10 is incorporated as a backlight of an LCD device, the spectral components of the light provided by apparatus 10 may be selected in accordance with the spectral characteristics of the color filters of the liquid-crystal panel. In other words, since a typical liquid-crystal panel comprises an arrangement of color filters operating at a plurality of distinct colors, the white light provided by apparatus 10 includes at least the distinct colors of the filters. This configuration significantly improves the optical efficiency as well as the image quality provided by the LCD device, because the optical losses due to mismatch between the spectral components of the backlight unit and the color filters of the liquid crystal panel are reduced or eliminated.

Thus, when white light is achieved by light sources emitting different colors of light (e.g., red light, green light, and blue light), the emission spectra of the light sources can be selected to substantially overlap the characteristic spectra of the color filters of an LCD panel. When apparatus 10 is supplemented by one or more photoluminescent layers, the emission spectra of the photoluminescent layers and, optionally, the emission spectrum or spectra of the light sources, can be selected to overlap the characteristic spectra of the color filters of an LCD panel. Typically, the overlap between a characteristic emission spectrum and a characteristic filter spectrum is about 70% spectral overlap, or about 80% spectral overlap, or about 90%.

Reference is now made to FIG. 2, which is a schematic illustration of a cross-sectional view of a system 100 for providing backlight illumination, according to some embodiments of the present invention.

In some embodiments of the present invention system 100 comprises a light-emitting sheet 102, and a light-conversion layer 104 spaced from sheet 102 and having therein light-conversion structures for spectrally converting light emitted from sheet 102. Sheet 102 preferably comprises a waveguide material embedded with one or more light sources 112, as further detailed hereinabove with respect to apparatus 10.

Sheet 102 can be made using a waveguide material having a refractive index greater than one. Representative examples of materials suitable for sheet 102 include, without limitation, TPU (aliphatic), which has a refractive index of about 1.50; TPU (aromatic), which has a refractive index of from about 1.58 to about 1.60; amorphous nylon such as the GRILAMID material supplied by EMS Grivory (e.g., GRILAMID TR90), which has a refractive index of about 1.54; the TPX (PMP) material supplied by Mitsui, which has a refractive index of about 1.46; PVDF, which has a refractive index of about 1.34; other thermoplastic fluorocarbon polymers; the STYROLUX (UV stabilized) material marketed by BASF, which has a refractive index of about 1.58; polymethyl methacrylate (PMMA) with a refractive index of about 1.5; and polycarbonate with a refractive index of about 1.5. Sheet 102 may consist of a single (core) layer or have a sandwich structure in which a core layer lies between opposed cladding layers. The thickness of the cladding layers (if present) is typically from about 10 μm to about 100 μm. The thickness of the core layer may vary from approximately 400 μm to approximately 1300 μm.

In various embodiments, the material from which sheet 102 is formed is transparent, is at least somewhat flexible, possesses at least some elongation capability, and/or is capable of being produced in a thermoplastic process. Very flexible materials such as silicone may be suitable, as well as less flexible materials such as PMMA or polycarbonate. The degree to which the chosen material is capable of bending may depend on the mode of assembling sets of elements into a surface. For example, some assembly procedures may require little or no bending. In other embodiments, the material is not inherently flexible; even a relatively stiff material, if thin enough, may exhibit sufficient mechanical flexibility to accommodate assembly as described herein. The waveguide elements may be manufactured by any suitable technique including, without limitation, co-extrusion, die cutting, co-injection molding, or melting together side-by-side in order to introduce bends that will facilitate assembly.

The principles of propagation of light within sheet 102 and emission of light out of the surface 102 are described in other patents by the present Inventor, see for example, U.S. Pat. Nos. 7,826,698, 8,272,758, the contents of which are hereby incorporated by reference.

Broadly speaking, the light typically propagates in sheet 102 according to the principles of total internal reflection, and is emitted out of the surface of sheet 102 by means of one or more components designed and configured to redirect the light such that the light incidents the inner surface at a sufficiently small angle (smaller than the critical angle for total internal reflection) to allow it to exit sheet 102, e.g., by refraction. The component can be implemented as an impurity that may serve as a scatterer. The impurity can include particles, beads, air bubbles, glass beads and/or other ceramic particles, rubber particles, silica particles and so forth, any of which may optionally be fluorescent particles or biological particles, such as, but not limited to, Lipids.

The redirecting components alternatively or additionally include quantum dots, nanocrystals, nanoprisms, miniprisms, microprisms, scattering metallic objects, resonance light scattering objects, solid prisms and the like. The redirecting components can alternatively or additionally include diffractive optical elements and/or regions with different indices of refraction, as known in the art.

In various exemplary embodiments of the invention sheet 102 comprises a reflecting surface 132 which prevents emission of light through the one surface of sheet 102 (the bottom surface, in FIG. 2) and therefore enhances emission of light through the opposite surface. Surface 132 can be made of any light reflecting material, and can be either embedded in or attached to sheet 102.

Layer 104 can comprise, or be similar to photoluminescent material 30 as further detailed hereinabove. In these embodiments, at least some of the light-conversion structures are light-conversion molecules. For example, the light-conversion molecules can effect phosphorescence, as further detailed hereinabove.

In some embodiments of the present invention at least some of the light-conversion structures of layer 104 are structured exhibiting quantum confinement. For example, the light-conversion structures can be a structure selected from the group consisting of a quantum dot, a quantum wire and a quantum well.

A “quantum dot,” as used herein, is a semiconductor crystalline structure with size dependent optical and electrical properties. Specifically, a quantum dot exhibits quantum confinement effects such that there is a three-dimensional confinement of electron-hole bound pairs or free electrons and holes. The semiconductor structure can have any shape. Preferably, the largest cross-sectional dimension of such structure is of less than about 20 nanometers, e.g., from about 0.2 nanometers to about 10 nanometers.

A “quantum wire,” as used herein, is quantum nanostructure that exhibits quantum confinement effects such that there is a two-dimensional confinement of electron-hole bound pairs or free electrons and holes. A quantum wire is typically embodied as a narrow elongated region in a sufficiently thin layer of a semiconductor compound. The thickness of the layer and width of the region are selected such as to provide the aforementioned two-dimensional confinement. Typically, the width and height of the quantum nanostructure are both less than 20 nm, e.g., from about 0.2 nanometers to about 10 nanometers.

A “quantum well,” as used herein, is a semiconductor crystalline structure that exhibits quantum confinement effects such that there is a one-dimensional confinement of electron-hole bound pairs or free electrons and holes. The semiconductor structure can have any shape.

In some embodiments of the present invention layer 104 converts the light emitted by the light sources in sheet 102 to substantially white light, e.g., using a dichromatic, trichromatic, tetrachromatic, or multichromatic approach. For example, layer 104 can absorb blue light and responsively emit yellow light. In some embodiments of the present invention layer 104 is additionally configured to absorb infrared light and responsively emit visible light. Materials suitable for these embodiments are known in the art and are commercially available, for example, from Phosphor Technology Ltd., England (see, e.g., www.phosphor-technology.com/products/laser.html). This embodiment is particularly useful for increasing the conversion ambient light (e.g., direct or indirect sunlight) by layer 104.

When system 100 is incorporated in a display, the display is made readable under high ambient illumination since it provides high brightness that overcomes the ambient light reflection and has a visible contrast ratio. The ambient light may be from about 10,000 lux over the display area partially cloudy day at noon) through about 40,000 lux (summer clear day at noon) up to about 100,000 lux (max summer clear day at noon at the equator) or more.

As used herein “contrast ratio” refers to the ratio between the brightness levels of the brightest area and darkest area of the same image.

In various exemplary embodiments of the invention the characteristic contrast ratio of a display incorporating layer 104 is at least 300:1 or at least 400:1 or at least 500:1 or at least 600:1.

The advantage of having layer 104 spaced from sheet 102 and from light source 112 is that it allows layer 104 to maintain a temperature that is close to the ambient temperature, because layer 104 has a relatively large area that facilitates heat exchange with the environment. This temperature is low since the passive panel is a low heat generator. This is particularly advantageous when layer 104 has phosphor molecules since at relatively low temperatures the phosphor quantum efficiency, hence also the amount of light conversion, is stable. Furthermore, although the LED light source may suffer more from the high temperature and the die junction may reach much higher temperature, which reduce the light source efficacy and may provide a small change in the emitted wavelength, the converted light is generally the same because the conversion effect by the phosphor molecules is not sensitive to small changes in the exciting wavelength.

The thickness of layer 104 is optionally and preferably selected in accordance with the characteristic emission direction of light out of layer 102. Specifically, the thickness of layer 104 is selected so as to establish a predetermined optical path length of the light in layer 104. Thus, for example, when the light is expected to be emitted from layer 102 at small angles (relative to the normal to the emitting surface of layer 102) the thickness of layer 104 is selected to be relatively large, compared to a situation in which the light is expected to be emitted from layer 102 at large angles. In various exemplary embodiments of the invention the thickness of layer 104 is calculated for establishing a predetermined optical path for blue light.

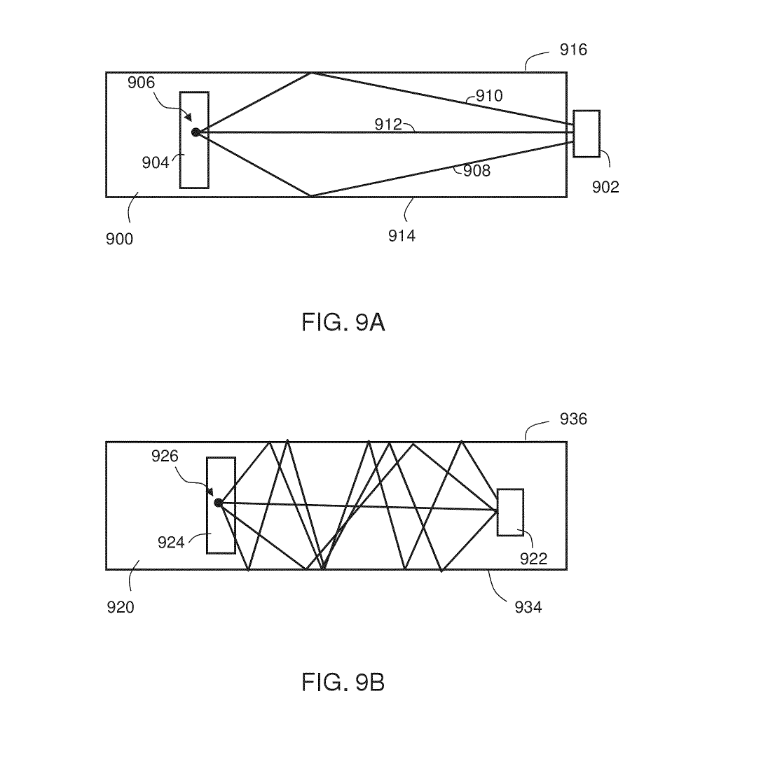

It was unexpectedly found by the present Inventor that when the light sources are embedded in sheet 102 the directionality of light output from the surface of sheet 102 is more uniform compared to a configuration in which the light sources are optically coupled to sheet 102 but are mounted external to sheet 102. This discovery will now be explained with reference to FIGS. 9A and 9B.

FIG. 9A shows a top view of waveguide sheet 900 and a light source 902 externally coupled to sheet 900. Light rays from source 902 enter sheet 900 at an angle which satisfies the optical coupling condition between source 902 and sheet 900. The rays propagate therein by total internal reflection. Sheet 900 includes an optical component 904 that redirects the light to an angle below the critical angle such that the light ray is emitted, as further detailed hereinabove. The present Inventors found that, for a given exit point 906 of light out of sheet 900, there is a very small number of scenarios which allow emission of light, because the range of angles at which the light enters the waveguide is relatively small. A first scenario is when a light ray 908 impinges on a side wall 914 and reflected in the direction of exit point 906. A second scenario is when a light ray 910 impinges on a side wall 916 opposite to side wall 914 and is reflected in the direction of exit point 906. A third scenario is when a light ray 912 is reflected from the top surface of sheet 900 (a surface parallel to the drawing), impinges on component 904 and is redirected to exit point 906.

Thus, in the configuration of FIG. 9A the light output is directional since for each exit point, there is a small number of exit directions. In practice, the number of different directions is typically no more than three. In order to provide uniform light output, a diffuser layer is required on top of surface 916 so as to scatter the three light rays of each exit point.

FIG. 9B shows a top view of a waveguide sheet 920 and a light source 922 embedded in sheet 920. Light rays from source 922 are emitted within sheet 920 in a plurality of directions and propagate therein by total internal reflection. Sheet 922 includes an optical component 924 that redirects the light to an angle below the critical angle for total internal reflection, as further detailed hereinabove. Unlike the situation in FIG. 9A, there are multiplicity of light rays that propagate in sheet 920, impinge on component 924 and redirected to exit point 926. For clarity of presentation the optical path of several rays is shown, but many rays emitted by source 922 eventually exit through point 926, at a large number of different directions. Thus, an advantage of having the light source embedded in the sheet is that the directionality light output is more uniform, so that a diffuser layer is not required.

System 100 optionally and preferably comprises at least one faceted optical film 106 being spaced from layer 104, further away from sheet 102. Faceted optical film 106 may be, for example, a brightness-enhancement film (BEF). Film 106 is optionally and preferably configured for collimating the light exiting layer 104, thereby increasing the brightness of the illumination provided by system 100. The faceted film may operate according to principles and operation of prisms. Thus, light rays arriving at the faceted film at small angles relative to the normal to the film are reflected, while other light rays are refracted. The reflected light rays are recycled back, through layer 104 into sheet 102 continue to propagate in sheet 102 and diffuse therein until they arrive at the film 106 at a sufficiently large angle. In an embodiment in which sheet 100 includes a reflecting surface 132, it prevents the light which is reflected from film 106 from exiting through the respective surface (the bottom surface in FIG. 2). Structured films are known in the art and are found in the literature, see, e.g., International Patent Application Publication No. WO 96/023649, the entire disclosure of which is incorporated by reference herein.

In various exemplary embodiments of the invention the light exits film 106 is generally white. This can be ensured by a judicious selection of layer 104, taking into account multiple spectral conversions corresponding to multiple reflections of light by film 106. Typically, the density of the light-conversion structures in layer 104 is lower than a density of the structures that would have been required for providing white light characterized by the color coordinate in the absence of film 106.

As use herein, “color coordinate” refers to a set (e.g., a triplet) of coordinate values in a color coordinate system, such as, but not limited to, the 1931 CIE XYZ color coordinate-system.

Thus, for example, suppose that, for a given sheet 102, a given density ρ₀ of the light-conversion structures in layer 104 and in the absence of film 106, the light exiting layer 104 is white and is characterized by a color coordinate (X₀,Y₀,Z₀), as expressed in the 1931 CIE XYZ color coordinate-system. For the same sheet 102, the same density ρ₀ of the light-conversion structures in layer 104 but in the presence of film 106, the light exiting layer 104 would be characterized by a color coordinate (X₁,Y₁,Z₁), which is different than (X₀,Y₀,Z₀) due to the multiple reflections from film 106. According to some embodiments of the present invention, when film 106 is employed, the density ρ₁ of the light-conversion structures in layer 104 is lower than ρ₀ wherein ρ₁ is selected such that such that the output of film 106 is characterized by (X₀,Y₀,Z₀).

It is to be understood that although light source 112 is illustrated as s ingle element in FIG. 2, this need not necessarily be the case, since, for some applications, it may be desired to have a plurality of light sources embedded in sheet 102. For example, light source 112 can represent an arrangement of a red light source, a green light source and a blue light source.

System 100 can also comprise a power source 110 connected to light source(s) 112 for powering the light sources. In various exemplary embodiments of the invention the connection of at least one of the light sources to power source 110 is independent (for example, the connection to the blue light source can be independent from the connection to the red and green light sources). This embodiment is particularly useful when it is desired to activate and deactivate one or more of the light sources independently from one or more other light sources. A representative example of such operation is to provide a non-white backlighting illumination, for example, during night time. Thus, for non-white output, one or more of the light sources that emit light of a particular wavelength or a particular range of wavelength (for example, the blue light source) is turned off, keeping the other light sources active.

Switching between different modes of operation can be done by a controller 120 which is preferably configure for activating power source 110 responsively to an operation mode signal. When the signal corresponds to a first operation mode, controller 120 activates power source 110 to power each of the red, green and blue light sources, and when the signal corresponds to a second operation mode, controller activates 120 power source 110 to power at least one of the red and green light sources, but not the blue light source. The present embodiments contemplate any combination of activated and switched off light sources, including, without limitation, R+G+B (red, green and blue light sources active), R+G (red and green light sources active, blue light source inactive), R+B (red and blue light sources active, green light source inactive), G+B (green and blue light sources active, red light source inactive), R (only red light source active, green and blue light source inactive), G (only green light source active, red and blue light source inactive), and B (only blue light source active, red and blue light source inactive).

The operation mode of system 100 can be selected by the user, for example, by means of a user interface 122, such as, but not limited to, a keyboard, a touch screen or a voice activated user interface. The operation mode can also be selected automatically. For example, system 100 can comprise a light sensor 124 for determining ambient light condition, wherein controller 120 automatically selects the operation mode responsively to the ambient light condition. Typically, but not necessarily, controller 120 selects an operation mode in which the blue light source is turned off during night time.

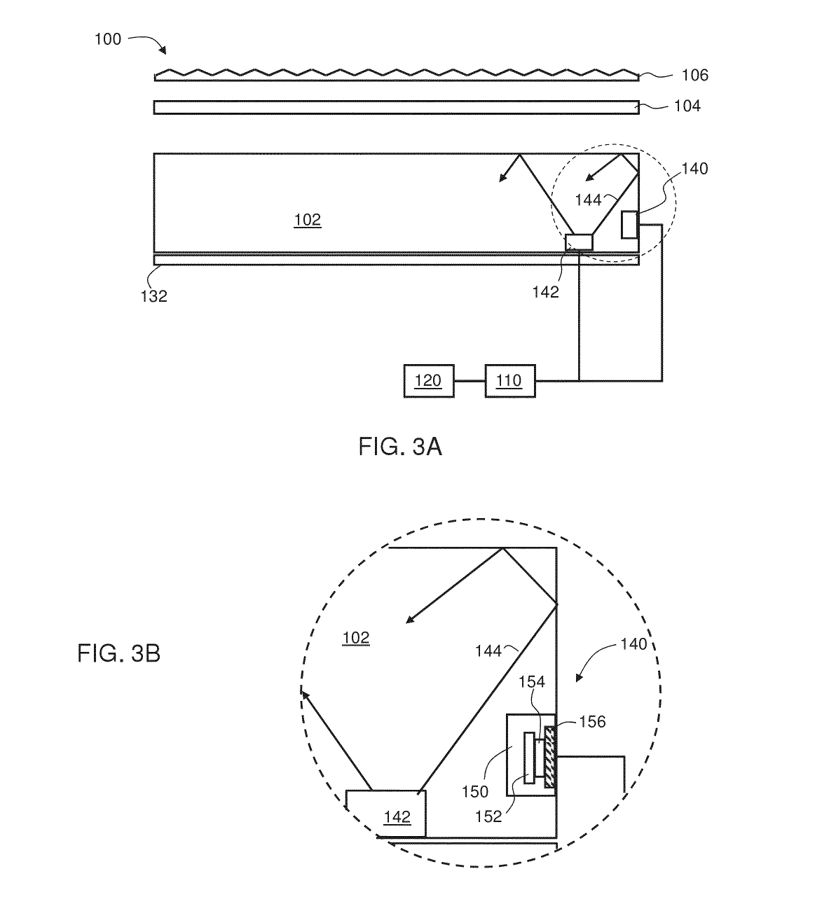

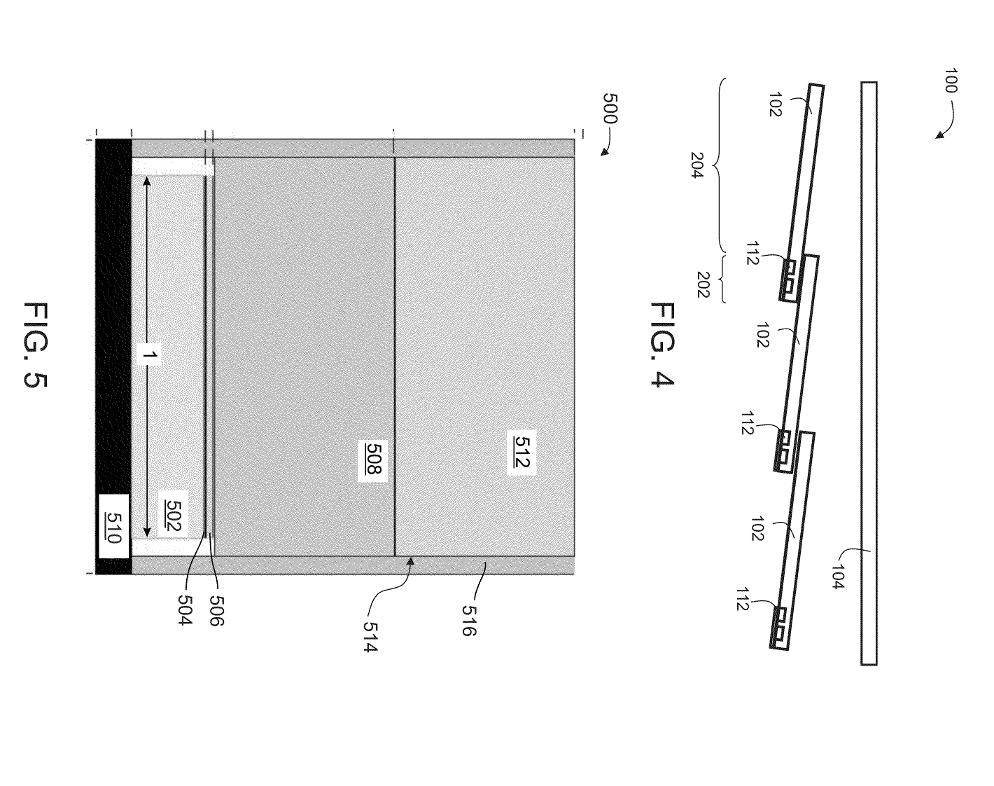

In some embodiments of the present invention sheet 102 comprises several sets of light sources, each being configured for generating light at a different continuous luminance range. A representative example of this embodiment is illustrated in FIGS. 3A and 3B.

FIG. 3A is a schematic illustration of system 100 in an embodiment of the invention in which light-emitting sheet 102 has a first set 140 of light sources and a second set 142 of light sources. FIG. 3B is a magnified illustration of the area enclosed by dashed circle in FIG. 3A.

First set 140 is configured for generating light at a first continuous luminance range, and second set 142 is configured for generating light at a second continuous luminance range. The first and second luminance ranges differ from each other. Typically, one of the sets (e.g., first set 140) is configured for generating relatively high luminance, over a range suitable for daytime viewing, while the other set (e.g., second set 142) is configured for generating relatively low luminance, over a range suitable for nighttime viewing. Representative examples for the first luminance range include, without limitation, from about 1 nit to about 20,000 nit, from about 1 nit to about 30,000 nit, and from about 1 nit to about 40,000 nit. Representative examples for the second luminance range include, without limitation, from about 0.05 nit to about 2 nit, from about 0.05 nit to about 5 nit, and from about 0.05 nit to about 10 nit. Preferably, the first and second ranges overlap.

The use of two or more sets of light sources, each set for a different luminance range, is useful for providing illumination at a wide dimming range. The combined luminance range of the two sets is defined from a minimal luminance to a maximal luminance and wherein the maximal luminance is at least 100,000 times or at least 200,000 or at least 300,000 or at least 400,000 or at least 500,000 or at least 600,000 or at least 700,000 or at least 800,000 higher than the minimal luminance.

This can be achieved by controller 120 which activates power source 110 to independently power sets 140 and 142 so as to provide a white light output characterized by a predetermined and generally constant color coordinate for any luminance within a combined luminance range encompassing both the first and the second luminance ranges. Thus, for any given luminance level, controller 120 selects the power that is applied to each set in order to provide illumination at the given luminance level, preferably while maintaining a generally constant characteristic color coordinate.

One of the sets, e.g., set 140 optionally and preferably includes light sources configured to generate a converted light, while the other set, e.g., set 142, preferably includes light sources configured for generating non-converted light, optionally of a relatively narrow range of wavelengths, for example, blue light sources. Set 140 can include any type of light source that emits a generally white light. For example, known in the art is a chip-level conversion (CLC) light source which includes a blue-emitting LED chip with a phosphor coating in direct contact with the LED chip (see, for example, U.S. Published Application No. 20100084964). In the schematic illustration of FIG. 3B, a light source of set 140 comprises a phosphor layer 152 deposited over a LED die 154 carried by a substrate 156, for example, using a wafer level coating technology. In various exemplary embodiments of the invention one or more of the light sources are embedded within an encapsulant 150.

The amount of conversion performed by layer 104 is preferably selected such that when a portion of the light emitted by the light sources of set 142 is converted by layer 104, a combination of a converted portion and a non-converted portion is generally white. The amount of conversion performed by the light sources of set 140 is selected such that when the light emitted from these sources is further converted by layer 104 a generally white light mixture is produced. Since the luminance of set 140 is higher than the luminance of set 140, the conversion efficiency of layer 104 is lower for set 140 than for set 142. This reduced efficiency is compensated according to some embodiments of the present invention by the chip-level conversion of set 140.

Sets 140 and 142 are optionally and preferably arranged in sheet 102 such that light 144 emitted by light sources of set 142 does not impinge on light sources of set 140. The advantage of this embodiment of the present invention is that it prevents light conversion of light 144 by the phosphor coating of light sources 140, so that all the conversion of light 144 is performed by layer 104. In the schematic illustration of FIGS. 3A and 3B, set 140 is embedded at or near the wall of sheet 102, however, this need not necessarily be the case, since, for some applications, it may not be necessary for set 140 is to be at or near the wall of sheet 102. For example, Set 140 can be embedded near or at the bottom surface of sheet 102, e.g., near set 142. In this configuration, the distance between sets 140 and 142 is preferably selected such that set 140 is not in the optical path of the light emitted by set 142.

System 100 optionally and preferably comprises a plurality of sheets 102 each acting as a modular light-emitting element. The sheets 102 are optionally and preferably tilable to facilitate uniformly illuminating surfaces of arbitrary size.

A representative planar, tilable illumination system 100 is illustrated in FIG. 4. Each sheet 102 may include an in-coupling region 202 and an out-coupling region 204 that optimize capture, retention, and emission of light. Light sources 112 are preferably embedded within the in-coupling region 202. In the out-coupling region 204, the light is emitted from sheet 102. Sheets 102 are optionally and preferably arranged in a partially-overlapping optical configuration so as to tile an area that is larger than the area of each individual sheet.

As used herein, “partially-overlapping optical configuration” refers to an arrangement of sheets in which each sheet includes at least one region which is optically exposed at the surface of the sheet. An “optically exposed region,” as used herein, refers to a region capable of establishing optical communication with the medium outside the sheet without being substantially absorbed, reflected or scattered from adjacent layers.

Thus, for each sheet, there is a substantially free optical path between the sheet and the medium outside the sheet, which optical path passes through the surfaces at the optically exposed regions of the layers. The optically exposed region can therefore emit light directed outwardly from the surface of the layer. In various exemplary embodiments of the invention the sheets are exposed at their out-coupling regions, wherein the out-coupling region of one sheet overlays the in-coupling region of an adjacent sheet, as schematically illustrated in FIG. 4.

It is appreciated by the present Inventor that a planar illumination area assembled from a plurality of sheets 102 may emit non-uniform light at the boundary regions, or “stitches,” between the tiled sheets.

There are several reasons why the stitches may emit non-uniform light. For example, the non-uniform light may be due to the configuration of the sheets, stray light in the system, and/or roughness or roundness in a sidewall of a sheet owing to, for example, the sheets themselves or their method of assembly. The structure of a planar illumination area that places each sheet at an angle to an adjacent sheet may create a problem of uniformity in the borders of the sheets due to the positioning of the axis of the progress of the light between the adjacent tiles. The direction of the light emission from the tile in the out-coupling region may be similar to the direction of the progress of the light in the sheet. When the tiles are positioned next to one another, a lack of uniformity may be created due to the non-continuity of the direction of the light emission between the tiles.

The non-uniform light may also be due to stray light in the system. The configuration in which the exposed region of one sheet is laid on the in-coupling region of an adjacent sheet may allow stray light to pass from an in-coupling region of one sheet, between the two adjacent sheets and then to emerge on the outside of the planar illumination area.

In addition, light emitted from a lower sheet close to the edge of an upper sheet may meet and be reflected from a sidewall of the upper sheet. The original trajectory of the light may thus be changed to the reflected path. Thus, the sidewall of the upper sheet may create a non-uniform light pattern near it because it reflects emitted light away from it.

Non-uniform light may also arise due to roughness and/or roundness of the sidewall of a sheet. For example, when two adjacent sheets are separated by a distance because of, e.g., imperfections in the sidewalls of the sheets, the gap between the sheets may also create a gap in the distribution of emitted light.

U.S. Pat. No. 7,826,698 discloses a technique in which the light is prevented from exiting the light-guide elements at their in-coupling regions or at the borders between light-guide elements.

The present Inventor discovered that light-conversion layer 104 can be used to reduce non-uniformities in the emitted light, without preventing the light from exiting the sheets at their in-coupling regions. In some embodiments of the present invention the sheets 102 are configured so as not to prevent emission of light at the in-coupling regions. This is unlike conventional systems which require the use of minors above and below the light sources so as not to allow any emission from the in-coupling regions.

In some embodiments of the invention layer 104 has a non-uniform distribution of light-conversion structures selected to reduce non-uniformities in light intensity at regions of overlap between the sheets.

In various exemplary embodiments of the invention system 100 is configured to provide substantially uniform illumination (e.g., with deviations of less than 20% or less than 10% or less than 5%) both with respect to the brightness (e.g., as expressed in nit units) and with respect to the color coordinate (e.g., as expressed in the 1931 CIE XYZ coordinate system).

The color coordinate can be defined as the ratio of the converted light (for example, yellow color, when layer 104 absorbs blue light and emit yellow light) and the unconverted light (for example, blue and optionally other colors, if exist). This ratio relates to the probability of photons to interact with the conversion structures (e.g., phosphor particles).

The brightness relates to the angular distribution and intensity of the emitted light. The angular distribution may be increased by increasing the density of light conversion structures so that there are more scattering events. The brightness can be reduced by increasing the density of light conversion structures since the light loses are increased by absorption in the material.

Thus, according to some embodiments of the present invention the brightness due to light emissions in the in-coupling region can be equalized to the brightness at the out-coupling region, using a different density of light conversion structures over the in-coupling regions. According to some embodiments of the present invention, the thickness of layer 104 is reduced over the in-coupling regions so as to reduce the optical path over the in-coupling region to reduce the amount of interactions of photons with the light conversion structures, preserving the color uniformity. According to some embodiments of the present invention the regions of layer 104 which overlay the in-coupling regions of sheet 102 have lower thickness as well as higher density of light conversion structures, compared to regions of layer 104 which overlay the out-coupling regions of sheet 102.

Optionally, scattering and absorbing particles are added to layer 104 at regions which overlay the in-coupling region of sheets 102 so as to further control the brightness and angular distribution.

The light-conversion structures of layer 104 absorb a portion of the light emitted from the sheets and emit light at a different wavelength. The light emitted from the light-conversion structures is typically isotropic and is therefore uniform. The unconverted light from sheets 102 is scattered by the light-conversion structures and is therefore emitted out also uniformly. This optionally and preferably apply without the use of any additional diffuser foil or the like and therefore reduces the number of optical components that are required to provide uniform illumination. Reduced number of components is advantageous from the standpoint of cost and liability.

The advantage of having a gap between sheets 102 and layer 104 is that it allows the light to propagate and spread so that any shaded region in the arrangement of sheets is also illuminated.

Reference is now made to FIG. 5 which is a schematic illustration of a light emitting system 500, according to some embodiments of the present invention. Light emitting system 500 can be embedded as a light source in sheet 102. The components of system 500 are preferably all assembled at the chip-level, namely without interposing packaging elements between adjacent components. The overall thickness of system 500 is preferably less than 2 mm, for example, from about 1 mm to about 1.5 mm, e.g., about 1.3 mm.

System 500 comprises a semiconductor light-emitting layer 502, which may be a p-n junction of a semiconductor material. Layer 502 can be any conventional LED such as, but not limited to, a UV or blue light LED. Such LEDs are known and typically consist of InGaN or AlGaN layers epitaxially grown on a substrate 510. Substrate 510 can be of any type known in the art of light emitting diode chips, including, without limitation, sapphire, alumina or single crystal SiC substrate.

The width of layer 502 is optionally and preferably from about 0.5 mm to about 3 μm. The active region of layer 502, generally shown at 504 emits light when layer 502 is biased, as known in the art. The thickness of the active layer 504 is typically several nanometers, for example, from about 2 μm to about 5 μm, e.g., about 3 μm. The overall thickness of layer 502 is typically less than a millimeter, for example, from about 0.1 mm to about 0.3 mm, e.g., about 0.2 mm.

System 500 preferably also comprises a light-conversion layer 506 which is directly disposed on layer 502 so that there is a direct contact between layers 504 and 506. Light-conversion layer 506 has light-conversion structures for spectrally converting light emitted from layer 504. In various exemplary embodiments of the invention the light-conversion structures of layer 506 are particles that effect phosphorescence. Suitable phosphor particles for use in the present embodiment include, but are not limited to, yellow-emitting phosphor e.g., cerium-activated yttrium aluminum garnet, Y₃AI₅Oi₂:Ce, phosphor (YAG:Ce), cerium-activated terbium aluminum garnet (TAG:Ce) phosphor, silicate-based phosphors, and the like. Also contemplated are phosphor blends such as the blend described in U.S. Pat. No. 6,765,237, the contents of which are hereby incorporated by reference. The thickness of layer 506 can be, for example, from about 10 μm to about 30 μm, e.g., about 20 μm.

In various exemplary embodiments of the invention system 500 comprises an infrared filter layer 508 directly contacting light-conversion layer 506 and configured for filtering out at least a portion of infrared light exiting light-conversion layer 506.

Typically, but not necessarily, layer 508 is designed and constructed to filter out near infrared light. The thickness of layer 508 can be, for example, from about 0.4 mm to about 0.6 mm, e.g., about 0.5 mm. Additionally, system 500 optionally comprises an infrared absorbing layer 512, directly contacting infrared filter layer 508 and being configured for absorbing at least a portion of infrared light exiting infrared filter layer 512. A representative example of an infrared absorbing material suitable for the present embodiments is, without limitation a Schott KG glass (e.g., KG1, KG2, KG3, KG4, KG5). The thickness of layer 508 can be, for example, from about 0.4 mm to about 0.6 mm, e.g., about 0.5 mm.

In some embodiments, the side walls 514 of system 500 are encapsulated by a blocking box 516 designed and constructed to block or reflect light the is emitted through walls 514.

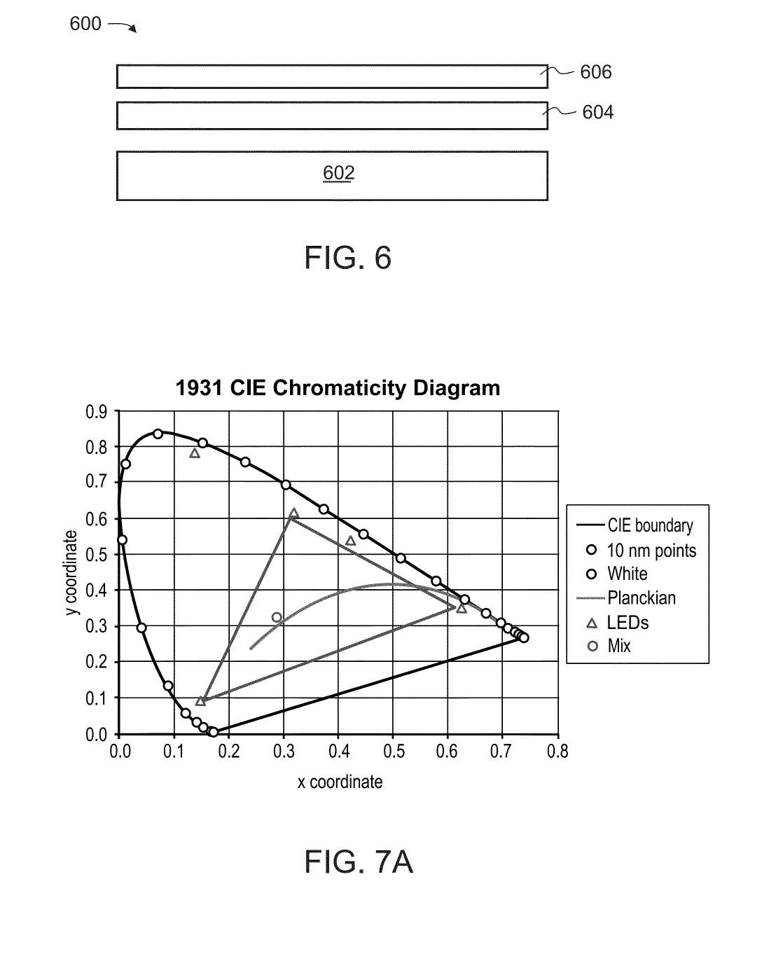

Reference is now made to FIG. 6 which is a schematic illustration of a passive display system 600, according to some embodiments of the present invention. System 600 comprises a backlight system 602, and a passive display panel 604. In various exemplary embodiments of the invention backlight system 602 incorporates system 100 described above. For example, backlight system 602 can be system 100. Passive display panel 604 can be, for example, a liquid crystal panel. When an electric field modulated by imagery data is applied to liquid crystal molecules in panel 604 the optical properties of the liquid crystal are changed and the illuminating light from backlight system 602 passing through panel 604 is encoded by the imagery data.

In some embodiments of the present invention system 600 also comprises a touch screen panel 606 which overlays panel 604 as known in the art. For example, touch screen panel 606 can be a capacitive touch screen, or resistive touch screen or a light reflecting screen.

System 600 can be incorporated in any appliance which requires a display, including, without limitation, a cellular telephone, a smart phone, a personal assistance device, a tablet, a desktop monitor, a portable computer, a television display, a GPS user interface and the like.

The word “exemplary” is used herein to mean “serving as an example, instance or illustration.” Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments.” Any particular embodiment of the invention may include a plurality of “optional” features unless such features conflict.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated to hereinabove and as claimed in the claims section below find support in the following examples.

### EXAMPLES

Reference is now made to the following examples, which together with the above descriptions illustrate some embodiments of the invention in a non limiting fashion.

### Specification Considerations

A preferred chromaticity of the backlight illumination system of the present embodiments is detailed, without limitation, in the following table.

| | X | Y |
|---|---|---|
| white | 0.290 | 0.320 |
| red | 0.622 | 0.348 |
| green | 0.320 | 0.615 |
| blue | 0.150 | 0.090 |

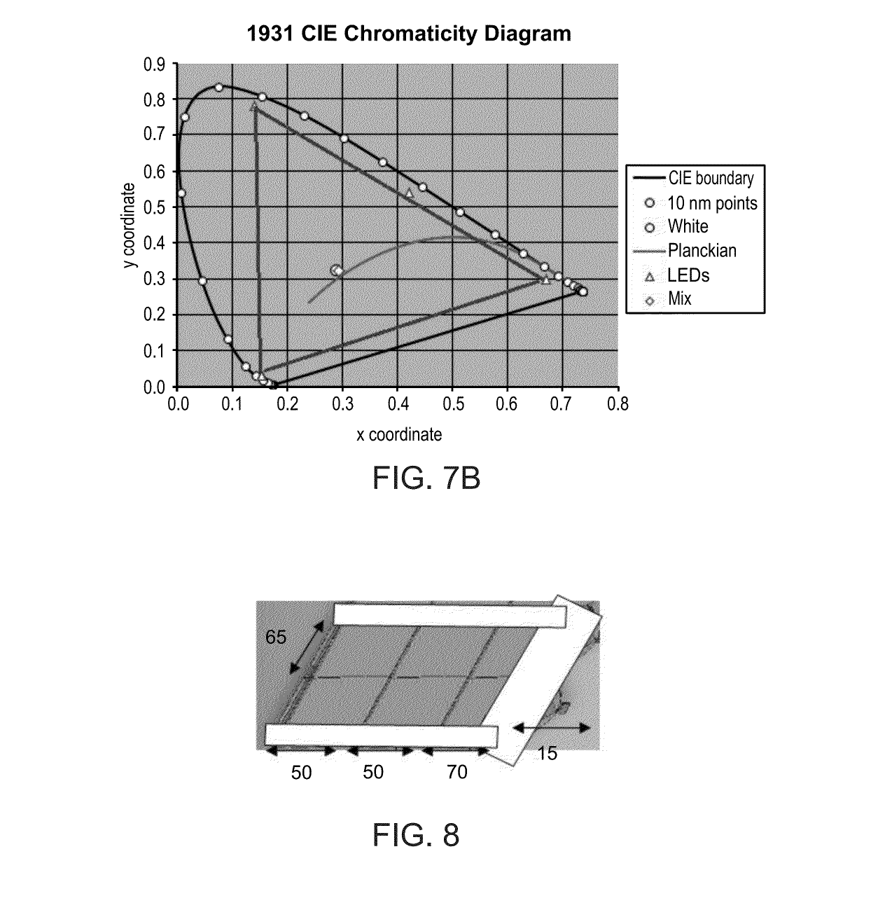

The values of x and y correspond to the 1931 CIE color coordinate system shown in FIG. 7A.

A representative example of a set of LEDs is detailed in the following table.

| | | |
|---|---|---|
| LED | Flux | color coordinate |

| No. | Y [lm] | x | Y |
|---|---|---|---|
| 1 | 47 | 0.15 | 0.0900 |
| 2 | 295 | 0.4222 | 0.5401 |
| 3 | 0 | 0.6220 | 0.3480 |
| 4 | 0 | 0.3200 | 0.6150 |
| 5 | 0 | 0.1410 | 0.7783 |

The resultant color mixture is Y=342, x=0.2892, y=0.3201. The color temperature of the mixture is CCT=8074, and the distance to the Planckian line, using the 1960 color space units is 0.01124.

An integration of blue LED chips with a yellow phosphor similar to a white CLC LED in combination with additional red and green LEDs can extend the color gamut of the display as demonstrated in FIG. 7B, and detailed in the table below.

The following table provides a representative example of a set of LEDs suitable for the present embodiments is detailed.

| | | |
|---|---|---|
| LED | Flux | color coordinate |

| No. | Y [lm] | x | Y |
|---|---|---|---|
| 1 | 15 | 0.1546 | 0.0302 |
| 2 | 300 | 0.4222 | 0.5401 |
| 3 | 5 | 0.6695 | 0.2998 |
| 4 | 40 | 0.1410 | 0.7883 |

The resultant color mixture is Y=360, x=0.2943, y=0.3214. The color temperature of the mixture is CCT=7698, and the distance to the Planckian line, using the 1960 color space units is 0.00901.

The diagram shown in FIG. 7B represents the extended color gamut capability to according to some embodiments of the present invention and is not to be considered as limiting.

A preferred luminance profile of a display system is detailed, without limitation, in the following table.

| | |
|---|---|
| viewing angle (degrees) | Lₘₐₓ |

| Horizontal | Vertical | (cd/m²) |
|---|---|---|
| 0 | 0 | >/=1500 |
| 30 | 0 | >/=700 |
| −30 | 0 | >/=700 |
| 0 | 30 | >/=700 |
| 0 | −30 | >/=700 |

The desired luminance profile, while taking into account the Liquid Crystal panel optical transmission (about 5%) allows calculating the preferred luminance of the backlight system. A preferred luminance of a backlight illumination system according to some embodiments of the present invention is about 30,000 nits. The luminance distribution angle can be achieved using one or more BEFs at cross state which enhance the brightness by a factor of about 3.

The backlight illumination system of the present embodiments preferably provides the above luminance level at Lambertian distribution and can thus provide a wide viewing angle since a Lambertian light distribution has half value width of ±60 degrees. This applies even in the absent of any BEF and therefore reduces the optical components in the backlight illumination system.

If desired, 1 or more BEFs can be incorporated to further enhance the brightness and reduce the power consumption. In these embodiments, the light conversion layer is designed to take into account more blue light that is being recycled from the BEF or BEFs. The light conversion layer can be thinner or with less light conversion structures to allow a portion of the recycled blue light to be converted into different wavelength and to be mixed and combined with the other emitted light to provide the required color coordinates.

A tiling configuration of the present embodiments can provide any desired illuminating active area by adjusting properly the length of the overlapping regions between the tiles as illustrated in FIG. 8. In the illustrated example, a backlight illumination system with an active area of 170 mm×130 mm which is suitable for a 8.4″ LCD, is assembled using a plurality of discrete sheets, each having dimensions of 85 mm×70 mm and illuminating area of 70 mm×70 mm. The sheet has a region of 15 mm×70 mm from which no illumination is provided. This region is covered by the other sheets as provided by the tiling arrangement. In some embodiments of the present invention a mask is placed over the margins of the arrangement in order to provide an exact illumination area. The light-conversion layer (not shown) is placed over the entire illumination area (see FIG. 4).

The luminance uniformity of the backlight system of the present embodiments is preferably UN=100*(Lmax−Lmin)/Lmax; 13 point measurement over the entire display area, and deviate by less than 15% for any color selected from the group consisting of red, green blue and white. Such luminance uniformity can be achieved by extracting the light out of the sheet using microstructures, such as, but not limited to, microprisms.

### Comparative Calculations

A conventional LCD such as the regular 7″ GPS display that was placed in a demo setup and provided 180 nits while using 2 BEFs. It contained 12 white side coupling LEDs that consumed 0.5 Watt. The display dimensions were 110 mm×65 mm.

In order to provide 1500 nits that allow the display to be visible under ambient sunlight illumination the same display consumes 4.2 Watt. This can be provided using 8 times more LEDs or brighter and larger LEDs. It was recognized by the present Inventor that such configuration is difficult to realize. Furthermore, for an 8.4″ display with an active area of 170 mm×128 mm, the same concepts that provides 1500 Nit consumes at least 12.7 Watt.

A display system having the backlight system of the present embodiments provides 2000 Nits while consuming about 3 Watt. Considering a sheet area of 70 mm×70 mm, a brightness of 1500 Nits can be achieved from the same active area to while consuming less than 2.3 Watt. A brightness of 1500 Nits can be achieved from an active area of 8.4″ display (170 mm×128 mm) while consuming less than 10.0 Watt.

The following table compares between the performances of a display device incorporating the backlight system of the present embodiments and a conventional display device.

| | | 8.4″ screen display | | | |
|---|---|---|---|---|---|
| | | Conventional | | | |
| | | 12 white side | | Inventive | |
| Light Source | | coupling LED | | Sheet 102 | |
| Display dimensions | Length | 110.0 | mm | 70.0 | mm |
| | Width | 65.0 | mm | 70.0 | mm |
| Display Area | | 0.0072 | m² | 0.0049 | m² |
| Display brightness | Measured | 180 | Nit | 2000 | Nit |
| Power consumption | Measured | 0.5 | Watt | 3.0 | Watt |
| Required Brightness | | 1500 | Nit | 1500 | Nit |
| power consumption | Measured | 4.2 | Watt | 2.3 | Watt |
| 8.4″ dimensions | Length | 170.0 | Mm | 170.0 | mm |
| | Width | 128.0 | Mm | 128.0 | mm |
| Preferred Display | | 0.0218 | m² | 0.0218 | m² |
| Area | | | | | |
| Power consumption | | 12.7 | Watt | 10.0 | Watt |

The backlight system of the present embodiments has an enhanced color coordinate stability at high temperature compared to conventional white LED displays. This is due to the remote light-conversion layer that significantly reduces the temperature change of the light-conversion structures since it is heated only to the ambient temperature and is not exposed to the high temperature of the LED die.

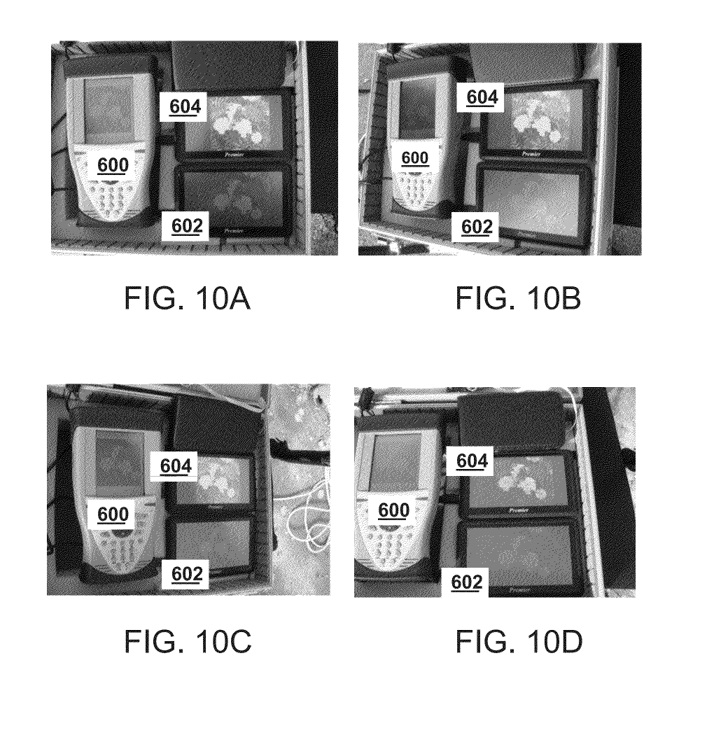

The present Inventor performed experiments using the backlight illumination system of the present embodiments. A backlight illumination system having a remote phosphor as schematically illustrated in FIG. 4 have been used to provide backlight illumination for a commercial 7″ LCD panels. FIGS. 10A-D are four images captured outdoor under sunlight conditions (40000 lux) during the experiments. Each image was captured at a different viewing angle, and includes a commercial hand-held professional GPS device 600, a commercial 7″ GPS display 602 having a conventional backlight to illumination, and a 7″ display 604 in which the LCD panel of the commercial 7″ GPS display 602 has been replaced by the backlight illumination system. As demonstrated, the backlight illumination system of the present embodiments significantly improved the brightness of the display at any viewing angle.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A system for providing backlight illumination, comprising:
a plurality of light-emitting sheets arranged in a partially-overlapping configuration, and a light-conversion layer spaced from said sheets and having therein light-conversion structures for spectrally converting light emitted from said sheets, and for reducing non-uniformities in light intensity at regions of overlap between said sheets.

2. The system according to claim 1, wherein said light-conversion structures are distributed non uniformly over said light-conversion layer.

3. The system according to claim 1, further comprising a faceted optical film spaced from said light-conversion layer and configured for redirecting light exiting said light-conversion layer to provide a redirected white light output characterized by a color coordinate.

4. The system according to claim 3, wherein said density of said structures in said layer is lower than a density of said structures that would have been required for providing white light characterized by said color coordinate in the absence of said film.

5. The system according to claim 1, wherein at least one of said sheets is embedded with a blue light source and at least one of a red light source and a green light source.

6. The system according to claim 1, wherein at least one of said sheets is embedded with a blue light source and at least one of a red light source and a green light source.

7. The system according to claim 1, wherein at least one of said sheets is embedded with a first blue light source and a second blue light source each emitting blue light of a different wavelength.

8. (canceled)

9. The system according to claim 6, further comprising:
a power source connected to said red said green and said blue light sources, wherein said connection to said blue light source is independent from said connection to said red and said green light sources; and
a controller, for activating said power source responsively to an operation mode signal, wherein when said signal corresponds to a first operation mode, said controller activates said power source to power each of said red, said green and said blue light sources, and when said signal corresponds to a second operation mode, said controller activates said power source to power at least one of said red and said green and light source, but not said blue light source.

10. The system according to claim 9, further comprising a user interface for allowing a user to select between said first operation mode and said second operation mode.

11. The system according to claim 9, further comprising a light sensor for determining ambient light condition, wherein said controller automatically selects between said first operation mode and said second operation mode responsively to said ambient light condition.

12. The system according to claim 1, wherein at least one of said sheets is embedded with a first set of light sources configured for generating light at a first continuous luminance range, and a second set of light sources configured for generating light at a second continuous luminance range being different from said first luminance range.

13. The system according to claim 12, further comprising a controller for independently activation said sets of light sources so as to provide a white light output characterized by a predetermined color coordinate for any luminance within a combined luminance range encompassing both said first and said second luminance ranges.

14. The system according to claim 13, wherein said first luminance range comprises luminance values which are higher than any luminance value within said second luminance range, wherein said first set of light sources is configured to generate a spectrally converted light, and wherein said light-conversion layer is selected so as to further convert a portion of said spectrally-converted light to form a generally white light mixture.

15. (canceled)

16. The system according to claim 13, wherein said combined luminance range is defined from a minimal luminance to a maximal luminance and wherein said maximal luminance is at least 100,000 times higher than said minimal luminance.

17. The system according to claim 12, wherein said first and said second sets of light sources are arranged in said sheet such that light emitted by light sources of said second set does not impinge on light sources of said first set.

18. The system according to claim 1, wherein at least one of said sheets is embedded with a light emitting system having a multilayer structure, said multilayer structure comprising:
a semiconductor light-emitting layer;
a light-conversion layer directly contacting said semiconductor layer and having therein light-conversion structures for spectrally converting light emitted from said semiconductor layer;
an infrared filter layer directly contacting said light-conversion layer and configured for filtering out at least a portion of infrared light exiting said light-conversion layer; and
a infrared absorbing layer, directly contacting said infrared filter layer and configured for absorbing a portion of infrared light exiting said infrared filter layer.

19. The system according to claim 14, wherein at least one of said sheets is embedded with a light emitting system having a multilayer structure, said multilayer structure comprising:
a semiconductor light-emitting layer;
a light-conversion layer directly contacting said semiconductor layer and having therein light-conversion structures for spectrally converting light emitted from said semiconductor layer;
an infrared filter layer directly contacting said light-conversion layer and configured for filtering out at least a portion of infrared light exiting said light-conversion layer; and
a infrared absorbing layer, directly contacting said infrared filter layer and configured for absorbing a portion of infrared light exiting said infrared filter layer.

20. The system according to claim 19, wherein an aggregate thickness of said semiconductor light-emitting layer, said light-conversion layer, said infrared filter layer and said infrared absorbing layer is less than 2 mm

21. The system according to claim 1, wherein each sheet comprises an in-coupling region and an out-coupling region, and wherein two adjacent sheets are arranged such an out-coupling region of one sheet overlays an in-coupling region of another sheet.

22. The system according to claim 21, wherein said sheets are designed and constructed so as not to block emission of light from said in-coupling region.

23. The system according to claim 22, wherein a density of said light-conversion structures is higher at regions of said light conversion layer that overlay said in-coupling region, than at regions of said light conversion layer that overlay said out-coupling region.

24. The system according to claim 22, wherein a thickness of said light-conversion structures is lower at regions of said light conversion layer that overlay said in-coupling region, than at regions of said light conversion layer that overlay said out-coupling region.

25. The system according to claim 1, wherein each sheet comprises an in-coupling region and an out-coupling region, and wherein two adjacent sheets are arranged such an out-coupling region of one sheet overlays an in-coupling region of another sheet.

26. The system according to claim 25, wherein a density of said light-conversion structures is higher at regions of said light conversion layer that overlay said in-coupling region, than at regions of said light conversion layer that overlay said out-coupling region.

27. The system according to claim 25, wherein a thickness of said light-conversion structures is lower at regions of said light conversion layer that overlay said in-coupling region, than at regions of said light conversion layer that overlay said out-coupling region.

28-29. (canceled)

30. The system according to claim 1, wherein said light-conversion structures comprise at least one structure exhibiting quantum confinement.

31. The system according to claim 30, wherein said structure exhibiting quantum confinement is selected from the group consisting of a quantum dot, a quantum wire and a quantum well.

32. The system according to claim 1, wherein said light-conversion layer is configured to absorb blue light and responsively emit yellow light.

33. The system according to claim 1, wherein said light-conversion layer is configured to absorb infrared light and responsively emit visible light.

34. A system for providing backlight illumination, comprising:
a light-emitting sheet;
a light-conversion layer spaced from said sheet and having therein light-conversion structures for spectrally converting light emitted from said sheet; and
a faceted optical film spaced from said light-conversion layer and configured for redirecting light exiting said light-conversion layer to provide a redirected white light output characterized by a color coordinate.

35. The system of claim 34, wherein a density of said structures in said layer is lower than a density of said structures that would have been required for providing white light characterized by said color coordinate in the absence of said film.

36-38. (canceled)

39. A method of providing a backlight illumination, comprising selecting an operation mode and activation the system according to claim 9.

40. A system for providing backlight illumination, comprising:
a light-emitting sheet embedded with a first set of light sources configured for generating light at a first continuous luminance range, and configured for generating light at a second continuous luminance range being different from said first luminance range; and
a controller for independently activation said sets of light sources so as to provide a white light output characterized by a predetermined color coordinate for any luminance within a combined luminance range encompassing both said first and said second luminance ranges.

41. The system of claim 40, further comprising a light-conversion layer spaced from said sheet and having therein light-conversion structures for spectrally converting light emitted from said light sources.

42. The system according to claim 41, wherein said first luminance range comprises luminance values which are higher than any luminance value within said second luminance range, wherein said first set of light sources is configured to generate a spectrally converted light, and wherein said light-conversion layer is selected so as to further convert a portion of said spectrally-converted light to form a generally white light mixture.

43. The system according to claim 42, wherein said second set of light sources is configured for generating non-converted light and wherein said light-conversion layer is selected so as to convert a portion of said non-converted light such that a combination of a converted portion and a non-converted portion is generally white.

44-48. (canceled)
